(19) United States
(12) Patent Application Publication
(10) Pub. No.: US 2018/0060926 A1
(43) Pub. Date: Mar. 1, 2018

(54) DETECTION OF TELECOMMUNICATION SERVICE PROVIDER NETWORK DETRACTOR TRIGGER EVENTS

(71) Applicant: AT&T Mobility II LLC, Atlanta, GA (US)

(72) Inventor: KEITH GUADAGNO, Fate, TX (US)

(21) Appl. No.: 15/251,498

(22) Filed: Aug. 30, 2016

(51) Int. Cl. G06Q 30/04; H04M 15/00; G06Q 30/02

(52) U.S. Cl. CPC G06Q 30/04; G06Q 30/0203; H04M 15/735

(57) ABSTRACT

A method may include a processor receiving survey data for a plurality of customers of a telecommunication service provider network for a given time period, the survey data identifying whether each of the customers is willing to recommend the telecommunication service provider network, identifying detractors from the plurality of customers, comprising customers that are not willing to recommend the telecommunication service provider network, and collecting customer event data for the detractors for the given time period, identify detractor trigger events from the customer event data, comprising billing events that are correlated with the detractors, detect an occurrence of one of the detractor trigger events associated with a first customer, and adjust a billing record for the first customer in response to detecting the occurrence of the one of the detractor trigger events, to result in a lesser charge to the first customer than without the adjusting.

The present disclosure relates generally to customer service troubleshooting for a telecommunication service provider network, and more particularly to automatically identifying customer events that may lead a customer to becoming a detractor, such as customer events that may impact a customer billing record, detecting occurrences of such events, and adjusting customer billing records when such events are detected.

### BACKGROUND

Various types of organizations provide customer service agents for handling a variety of customer-facing issues. For example, a telecommunication service provider network may staff a call center with customer service agents for handling issues relating to billing, service disruption, adding and removing features from service plans, endpoint device troubleshooting, and so forth. In some cases, customers may contact the telecommunication service provider network by telephone at a call center. In other cases, a telecommunication service provider network may provide customer service agents that are available for network-based chat conversations, e.g., instant messages, text messages, emails, and so forth. In some cases, customers may become dissatisfied with a telecommunication service provider network whether due to billing disputes, prolonged contract negotiations, slow repairs or deployments of new services, multiple calls to resolve problems, and so forth. The telecommunication service provider network may learn of a customer's dissatisfaction in a variety of ways and may then attempt to rectify the customer relationship. However, a reactive contact that occur after a negative event, or negative events, may fail to rectify a customer's impression such that the customer may remain unwilling to recommend the telecommunication service provider network to others.

### SUMMARY

In one example, the present disclosure provides a method, computer-readable medium, and device for adjusting a billing record for a customer in response to detecting an occurrence of a detractor trigger event. For example, a method may include a processor of a telecommunication service provider network receiving survey data for a plurality of customers of the telecommunication service provider network for a given time period, the survey data identifying whether each of the plurality of customers is willing to recommend the telecommunication service provider network, and identifying detractors from the plurality of customers, the detractors comprising customers that are not willing to recommend the telecommunication service provider network. In addition, the processor may collect customer event data for the detractors for the given time period and identify detractor trigger events from the customer event data. In one example, the detractor trigger events comprise billing events from the customer event data that are correlated with the detractors. The processor may further detect an occurrence of one of the detractor trigger events associated with a first customer of the telecommunication service provider network and adjust a billing record for the first customer in response to detecting the occurrence of the one of the detractor trigger events, where the adjusting results in a lesser charge to the first customer than without the adjusting.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication service provider network, according to the present disclosure;

FIG. 2 illustrates an example of how customer events may be correlated with detractors, according to the present disclosure;

FIG. 3 illustrates an example flowchart of a method for adjusting a billing record for a customer in response to detecting an occurrence of a detractor trigger event; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and devices for adjusting a billing record for a customer in response to detecting an occurrence of a detractor trigger event. In one example, customer event data for customers of a telecommunications service provider, such as the products and services purchased, the household, business, or organization size, pre-sale and post-sale activities, and so forth may be correlated to customer experience survey data in order to identify what customer traits and operational events have a higher correlation with a customer becoming a detractor (i.e., not willing to recommend the telecommunication service provider network to others). Once the operational events that have a negative impact on a customer's likelihood to recommend are determined (those operational events that are most correlated with customers reporting to be detractors/not willing to recommend), the telecommunication service provider network may implement event monitoring in order to detect the occurrence of such events and proactively intervene right at or even before the time that a customer becomes aware of a problem. Such a system may prevent or mitigate a propensity of a customer to become a detractor, and may maintain a customer's overall positive impression and willingness to recommend the telecommunication service provider network.

For example, customer lifecycle activities across various operational data sources (e.g., firmographics, products, revenue, pricing, contracting, ordering, billing, repair, interactive voice response (IVR), and online) may be collected in real time and analyzed to determine operational events that can cause a customer to become a detractor, referred to herein as “detractor trigger events”. In accordance with the present disclosure, the detractor trigger events may specifically comprise billing events; that is operational events that may impact a customer billing record. In one example, customers may be placed in one of three categories: promoters, passives, and detractors, based upon customers' self-reported survey responses. In one example, a customer's willingness to recommend may also be characterized by a “net promoter score”. In one example, operational events that most negatively influence a “willingness to recommend” may be determined from customers' self-reported problems and/or from operational data (broadly, “customer event data”) that is gathered from one or more systems of the telecommunication service provider network, such as: a billing system, a customer relationship management (CRM) system, a trouble ticket system, an ordering system, a fulfillment system, a contracting system, and so forth. In particular, pre-survey operational data for customers is gathered and is then analyzed in connection with customers' survey responses to identify operational events which have a higher correlation to customers who are detractors. In one example, different detractor trigger events may be identified for different categories of customers, such as residential customers, small business, mid-market, or enterprise customers, and so forth. Once detractor trigger events are identified, the telecommunication service provider network may then automatically detect occurrences of detractor trigger events and automatically intervene, prior to customers becoming aware of the problem(s) and prior to the customers contacting the telecommunication service provider network, in order to preserve the customers' potential willingness to recommend.

As mentioned above, in one example, the detractor trigger events that are identified may comprise operational events that impact billing records. This may include an excess usage event, e.g., a customer exceeding a contractual number of voice minutes, text messages, or a data volume, or a usage of bandwidth in excess of a contracted bandwidth, a contract end event, e.g., where a billing rate for a customer may jump to a higher non-contractual rate, a shortfall event, e.g., where the customer has agreed to use/purchase a minimum level of services per week, per month, or for some other time period, and where the customer does not meet such amount and is nevertheless charged for the shortfall, a late or defective new service installation, e.g., where the customer is charged for the new service even though the new service is not yet installed, is not working properly or is misconfigured, and so on. Accordingly, in various examples, the automatic intervention(s) may include adjusting a billing record for a customer in response to detecting a detractor trigger event. In one example, the adjusting results in a lesser charge to the first customer than without the adjusting.

For instance, a detractor trigger event comprising an excess usage event may be detected, and the customer billing record may be adjusted to provide a most favored customer rate for the excess usage associated with the excess usage event. For example, the customer may be charged at a best rate that is offered to other customers. In another example, the customer may be charged at a rate that is equivalent to a rate for usage that is not in excess of a contractual amount. For instance, if a customer's contractual rate is 2 gigabytes (GBs) per month for $20.00, usage in excess of 2 GB will not be charged at a higher rate which the telecommunication service provider network is entitled to charge (e.g., $15.00 per GB in excess of 2 GB, or some other higher amount), but will be charged at the same rate for usage that is not in excess of 2 GB (e.g., $10.00 per GB). In another example, the detractor trigger event that is detected may comprise a contract end event, where the customer billing record may be charged at a higher non-contractual rate after an end of a contractual time period associated with the contract, and where the adjusting the billing record may instead comprise providing a contractual service rate according to a contract that was in place prior to the contract end event. In another example, the detractor trigger event that is detected may comprise a contract shortfall event, and the billing record may be adjusted as follows. A customer account of the customer may be charged in an amount associated with the contract shortfall event for a first billing period. Thereafter, a credit may be provided to the customer account for at least a second billing period that is subsequent to the first billing period, where the credit corresponds to the amount charged to the customer account in the first billing period for the contract shortfall. In still another example, the detractor trigger event that is detected may comprise a late disconnect event, where a telecommunication service of a customer is disconnected after a contractual date or a target date by which the telecommunication service provider network agreed to disconnect the service. In such an example, the adjusting the billing record may comprise removing a charge for the telecommunication service for a time period after the contractual date or the target date has passed.

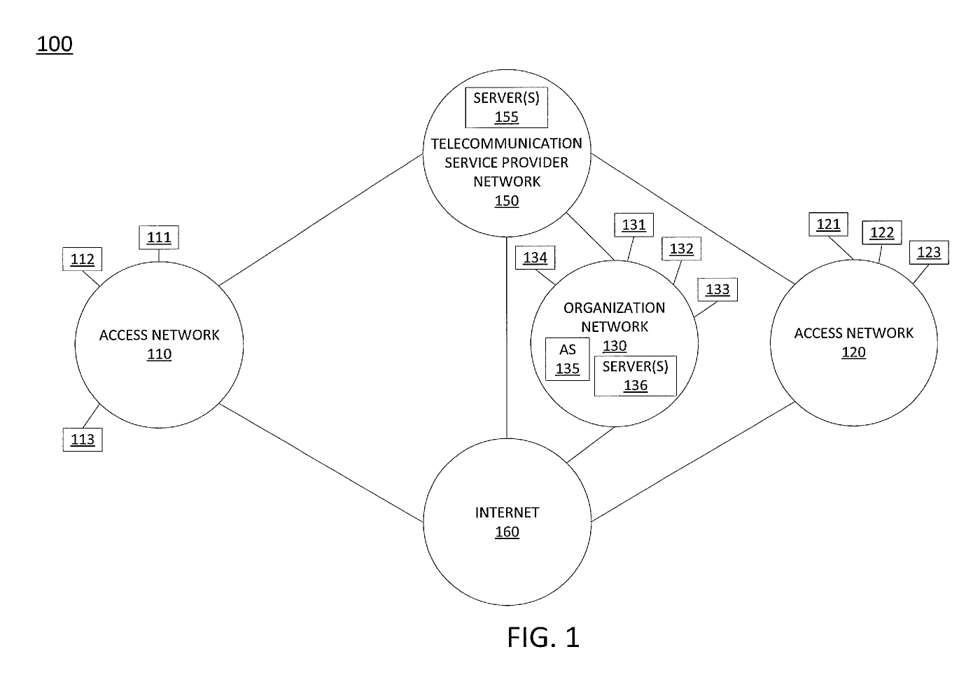

Historically, a customer who is a detractor is contacted on a reactive basis. The reactive contact occurs after the negative operational event(s) that erode(s) the customer's willingness to recommend. For example, the detractor may have a problem with a large monthly bill increase as compared to a prior month and may be frustrated with the amount of time and effort expended to resolve the problem. For example, the customer's reduced-rate contract period may have expired. The customer may have been eligible to renew at the reduced rate, and a proactive contact of the customer to notify the customer of this opportunity may have prevented the problem altogether. In accordance with examples of the present disclosure, the detractor trigger events that can cause the customers' willingness to recommend to erode are detected, and automatic mitigation measures are deployed prior to the customer contacting the telecommunication service provider network, and in some cases, prior to the customer becoming aware of the problem. Thus, negative impacts on the customer's relationship may be avoided. Examples of the present disclosure may also generate reports to track the reduction in the detractor trigger events leading to customers becoming detractors. Additionally, examples of the present disclosure enable a telecommunication service provider to determine the behaviors and profile of a promoter, which would in turn allow the telecommunication service provider to pivot customers experience and strategic decisions into that direction. The end result is proactive resolution, modeling business best practices to fit the profile of customer promoters and an increase and retention of revenues. In addition, examples of the present disclosure may continuously refresh the detractor trigger events through remodeling based on new customer survey responses, new customer self-reported problems, new operational data and/or new operational data sources, and so forth. These and other aspects of the present disclosure are discussed in greater detail below in connection with the examples of FIGS. 1-4.

In addition, it should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

To aid in understanding the present disclosure, FIG. 1 illustrates an example system 100 comprising a plurality of different networks for supporting the adjusting a billing record for a customer in response to detecting an occurrence of a detractor trigger event, in accordance with the present disclosure. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, 121-123, and telecommunication service provider network 150 relating to voice telephone calls, communications with web servers via the Internet 160 and/or other networks 130, 140, and so forth. Access networks 110 and 120 may also transmit and receive communications between endpoint devices 111-113, 121-123 and other networks and devices via Internet 160.

For example, one or both of access networks 110 and 120 may comprise an ISP network, such that 111-113 and/or 121-123 may communicate over the Internet 160, without involvement of telecommunication service provider network 150. Endpoint devices 111-113 and 121-123 may each comprise a telephone, e.g., for analog or digital telephony, a mobile device, a cellular smart phone, a laptop, a tablet computer, a desktop computer, a plurality or cluster of such devices, and the like. In one example, any one or more of endpoint devices 111-113 and 121-123 may further comprise software programs, logic or instructions for providing a customer service interface in accordance with the present disclosure, e.g., to facilitate receiving and responding to customer satisfaction surveys of the telecommunication service provider network 150, e.g., through text message chats, multimedia chats, interactive forms, and so forth, in addition to landline or cellular telephony or voice communications.

In one example, the access networks 110 and 120 may be different types of access networks. In another example, the access networks 110 and 120 may be the same type of access network. In one example, one or more of the access networks 110 and 120 may be operated by the same or a different service provider from a service provider operating telecommunication service provider network 150. For example, each of access networks 110 and 120 may comprise an Internet service provider (ISP) network, a cable access network, and so forth. In another example, each of access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide mobile core network 130 functions, e.g., of a public land mobile network (PLMN)-universal mobile telecommunications system (UMTS)/General Packet Radio Service (GPRS) core network, or the like. In still another example, access networks 110 and 120 may each comprise a home network, which may include a home gateway, which receives data associated with different types of media, e.g., television, phone, and Internet, and separates these communications for the appropriate devices. For example, data communications, e.g., Internet Protocol (IP) based communications may be sent to and received from a router in one of access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs) and/or home networks, and the like.

In one example, organization network 130 may comprise a local area network (LAN), or a distributed network connected through permanent virtual circuits (PVCs), virtual private networks (VPNs), and the like for providing data and voice communications. In one example, organization network 130 links one or more endpoint devices 131-134 with each other and with Internet 160, telecommunication service provider network 150, devices accessible via such other networks, such as endpoint devices 111-113 and 121-123, and so forth. In one example, endpoint devices 131-134, comprise devices of organizational agents, such as customer service agents, or other employees or representatives who are tasked with addressing customer-facing issues on behalf of the organization that provides organization network 130. In one example, endpoint devices 131-134 may each comprise a telephone for analog or digital telephony, a mobile device, a cellular smart phone, a laptop, a tablet computer, a desktop computer, a bank or cluster of such devices, and the like.

In one example, any one or more of endpoint devices 131-134 may comprise software programs, logic or instructions for providing a customer service interaction chat conversation interface for facilitate interactive customer service communications between customers and customer service agents, e.g., as an alternative or in addition to telephony or voice communications. In this regard, voice calls and interactive chat conversations between customers and organizational agents may be facilitated via one or more of telecommunication service provider network 150 and Internet 160.

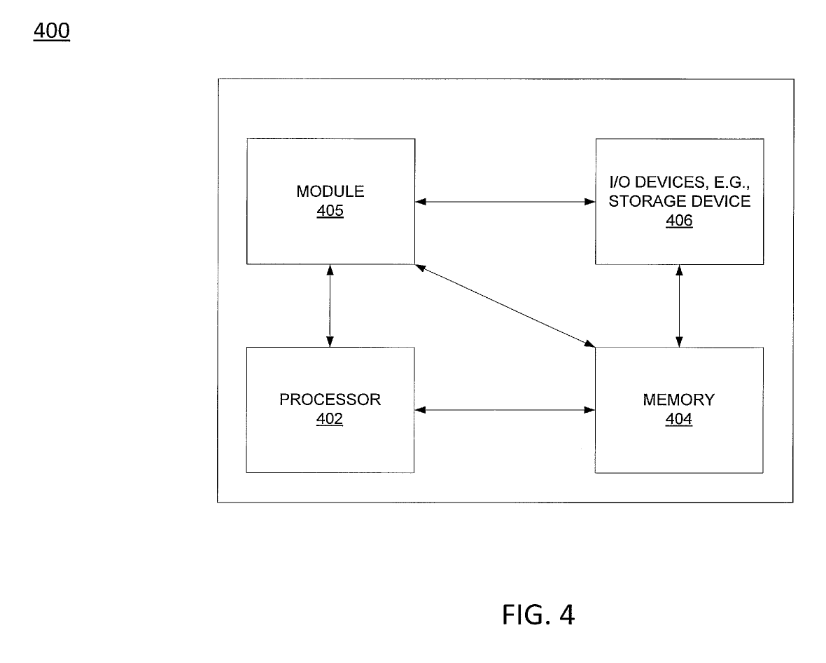

In one example, organization network 130 may also include an application server (AS) 135. In one example, AS 135 may comprise a computing system, such as computing system 400 depicted in FIG. 4, and may be configured to provide one or more functions for adjusting a billing record for a customer in response to detecting an occurrence of a detractor trigger event, in accordance with the present disclosure. For example, AS 135 may be configured to perform one or more steps, functions, or operations in connection with the example method 300 described below.

In one example, organization network 130 may be associated with the telecommunication service provider network 150. For example, the organization may comprise the telecommunication service provider, where the organization network 130 comprises devices and components to support customer service representatives, and other employees or agents performing customer-facing functions. For instance, endpoint devices 111-113 and 121-123 may comprise devices of customers, who may also be subscribers in this context. In one example, the customers may call via a telephone or engage in text or multi-media based chat conversations via endpoint devices 111-113 and 121-123 with customer service representatives using endpoint devices 131-134.

In one example, the system 100 may also include one or more servers 136 and/or one or more servers 155 in organization network 130 and telecommunication service provider network 150 respectively. In one example, the servers 136 and/or 155 may each comprise a computing system, such as computing system 400 depicted in FIG. 4, and may be configured to host one or more centralized system components for supporting the adjusting a billing record for a customer in response to detecting an occurrence of a detractor trigger event. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a billing system, a customer relationship management (CRM) system, a trouble ticket system, an inventory system (IS), an ordering system, an enterprise reporting system (ERS), an account object (AO) database system, and so forth. It should be noted that in one example, a centralized system component may be hosted on a single server, while in another example, a centralized system component may be hosted on multiple servers, e.g., in a distributed manner.

In accordance with the present disclosure, in one example, AS 135 may collect customer event/operational data from one or more centralized system components (e.g., servers 155 and/or servers 136) for customers associated with endpoint devices 111-113 and 121-123. In one example, the centralized system components may forward the customer event data to AS 135 on a periodic basis, when a certain quantity of data has been collected and is ready to transmit, etc. Alternatively, or in addition, AS 135 may query the centralized system component(s), e.g., periodically or on some other basis, in order to retrieve the customer event data. For each customer, the customer event data from a trouble ticket system may include: information regarding trouble tickets generated with respect to telecommunication services for the customer, e.g., the number of tickets in a given time period, the time to resolve each of the trouble tickets, the number of times the customer was contacted in order to resolve each of the trouble tickets, the number of times the customer called in connection with resolving the trouble ticket, and so forth. Similarly, the customer event data from a CRM system may include contract end dates for various customers, while the customer event data from a billing system may include a contractual shortfall amount for a customer for a given billing period. Other types of customer event data may include excess network resource utilization (e.g., excess voice usage, excess text or multimedia message usage, excess data usage, excess bandwidth usage, and so forth).

In addition, in one example, AS 135 may also interact with endpoint devices 111-113 and 121-123 to provide surveys and to receive responses to questions within the surveys. The surveys may inquire as to customers' level of satisfaction with various aspects of the services provided to the customers by the telecommunication service provider network. In one example, the surveys may include at least an inquiry as to whether the customer is willing to recommend the telecommunication service provider network to others. Thus, the customer responses may include at least an answer of whether the customer is willing to recommend the telecommunication service provider network to others. In addition, in one example, the surveys may ask whether a customer has experienced any of a number of particular problems within a given time period, such as whether the customer has experienced a loss of service for greater than six hours within the last three months, whether the customer has had a service problem that required more than two phone calls with technical support personnel in order to resolve, whether the customer has incurred overage charges, shortfall charges, and so forth. The surveys may be in an electronic format, such as extensible markup language (XML) form based surveys and/or interactive webpages, or may be presented via automated phone calls to endpoint devices 111-113 and 121-123. For instance, in one example, AS 135 may comprise an interactive voice response (IVR) system.

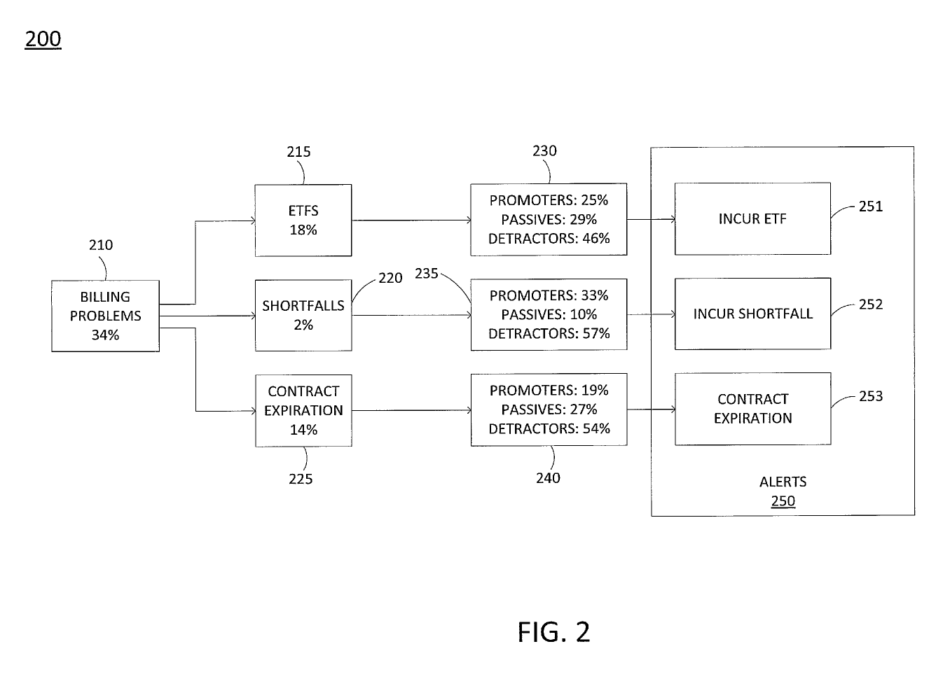

In accordance with the present disclosure AS 135 may identify customers who are detractors, based upon the customers' survey responses indicating whether the customers are willing to recommend the telecommunication service provider network. In one example, AS 135 may then access or retrieve customer event data related to the detractors. For instance, as described above AS 135 may gather customer event data from one or more centralized system components. AS 135 may then correlate various operational events from the customer event data with those customers who are detractors. For example, when a percentage of the detractors greater than a threshold are determined to have experienced an operational event, the operational event may be identified as a detractor trigger event. The identification of detractor trigger events is described in greater detail below in connection with the example of FIG. 2. Upon the identification of one or more detractor trigger events, AS 135 may then continue to monitor customer event data to detect occurrences of detractor trigger events. In one example, the detractor trigger events that AS 135 monitors may comprise billing events, i.e., operational events that may impact customer billing records, such as excess usage events, contract end events, shortfall events, and so on. When a detractor trigger event is detected by AS 135, AS 135 may then implement preventative measures in order to mitigate a propensity of a customer to become a detractor. In particular, in one example, AS 135 may adjust a billing record for a customer in response to detecting an occurrence of a detractor trigger event that may impact the customers billing record. For example, AS 135 may adjust the billing record to result in a lower charge to the customer.

In addition, it should be realized that the network 100 may be implemented in a different form than that illustrated in FIG. 1, or may be expanded by including additional endpoint devices, access networks, network elements, application servers, etc. without altering the scope of the present disclosure.

To further aid in understanding the present disclosure, FIG. 2 illustrates an example process 200 of identifying detractor trigger events and configuring alerts based upon occurrences of such detractor trigger events, in accordance with the present disclosure. As illustrated in FIG. 2, process 200 may include a network-based server determining, at block 210, that 34 percent of customers responding to a survey from the telecommunication service provider network experienced a billing event, or billing problem, in a given time period, e.g., a six month time period prior to the survey, a three month time period, etc. In one example, the percentage of customers experiencing a billing event in the time period may be determined from the customers' survey responses which may explicitly indicate that a billing problem was experienced. Alternatively, or in addition, the percentage of customers experiencing billing events in the time period may be determined from operational data/customer event data from various data sources within the telecommunication service provider network, e.g., from a billing system, from a CRM system storing data regarding a number of times each customer has contacted the telecommunication service provider network to inquire about a billing issue, and so forth.

The server may next determine several types of billing events that were experienced by the customers during the given time period. For instance, at block 215 the server may determine from the customer event data that 18 percent of the customers experienced early termination fee (ETF) events, at block 220 the server may determine that 2 percent of the customers experienced contractual shortfall events, and at block 225 the server may determine that 14 percent of customers experienced contract expiration events. The server may then determine with respect to each type of billing event (e.g., that was experienced by at least one customer within the given time period), the percentages of customers experiencing the billing event that reported on the survey as being a promoter (willing to recommend), a detractor (not willing to recommend), or neutral/passive with respect to the telecommunication service provider network. For example, at block 230 the server may determine that 25 percent of customers experiencing early termination fee events reported being promoters, 46 percent reported being detractors, and 29 percent reported being passive. At block 235, the server may determine that 33 percent of customers experiencing contractual shortfall events reported being promoters, 57 percent reported being detractors, and 10 percent reported being passive. Similarly, at block 240, the server may determine that 19 percent of customers experiencing contract expiration events reported being promoters, 54 percent reported being detractors, and 27 percent reported being passive.

At block 250, the server may determine that the early termination fee, contractual shortfall, and contract expiration events comprise detractor trigger events. In one example, operational events (e.g., billing events) may be determined to be detractor trigger events when greater than a threshold percentage of customers experiencing the same operational event report as being detractors. For instance, in one example, the telecommunication service provider may consider than any billing event for which greater than 40 percent, or some other threshold percentage of experiencing customers report as being detractors should be considered as a detractor trigger event. Thus, in the example of FIG. 2, at sub-block 251 the server may determine that incurring an early termination fee is a detractor trigger event, at sub-block 252 the server may determine that incurring a contractual shortfall charge is a detractor trigger event, and at sub-block 253 the server may determine that experiencing a contract expiration is also a detractor trigger event, since in all three cases, the percentage of detractors is greater than 40 percent.

In addition, in one example, at block 250 the server may further configure automatic alerts for future occurrences of the operational events (e.g., billing events) that are determined to be detractor trigger events. For example, various systems within the telecommunication service provider network may continue to report or transmit customer event data/operational data to the server from which the server may then determine that a detractor trigger event has occurred with respect to a customer. When the occurrence of such an event is detected, the server may then automatically implement a remedial action with respect to the customer experiencing the detractor trigger event. For example, with respect to a detractor trigger event comprising a billing event, the server may adjust a billing record for a customer when it is detected from the operational data that the customer experienced the billing event. For instance, the server may waive or remove an early termination fee from a customer billing record in response to detecting an early termination fee event for the customer, e.g., if the server also determines from the operational data that the customer has subscribed to a new or a different service from the telecommunication service provider. Similarly, the server may adjusting the billing record to provide a contractual service rate according to a contract that was in place prior to the contract end event, e.g., when a contract end event is detected. In another example, when a contractual shortfall event is detected, the server may provide a credit to a customer account for a billing period subsequent to the billing period in which an amount was charged to the customer account for the contract shortfall event. It should be noted that the example of FIG. 2 includes three billing events that may be determined to be detractor trigger events. However, in other examples, various additional billing events comprising detractor trigger events may be determined, various alerts may be configured, and various adjustments to customer billing records may be implemented in accordance with the present disclosure.

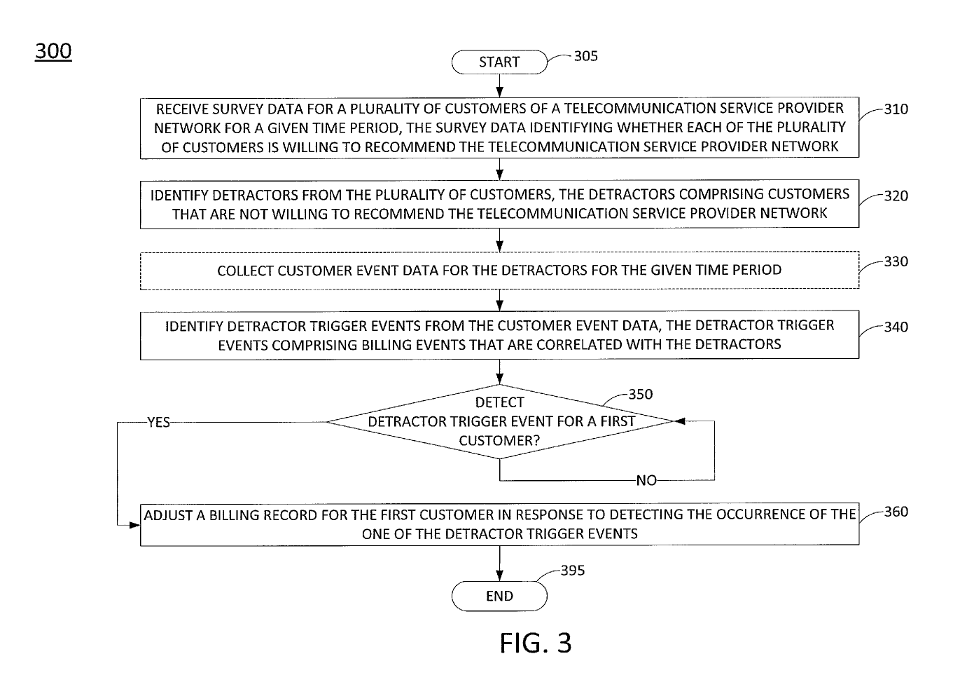

FIG. 3 illustrates an example flowchart of a method 300 for adjusting a billing record for a customer in response to detecting an occurrence of a detractor trigger event. In one example, the steps, operations, or functions of the method 300 may be performed by any one or more of the components of the system 100 depicted in FIG. 1. For instance, in one example, the method 300 is performed by the application server 135, or by application server 135 in conjunction with other components of the system 100. Alternatively, or in addition, one or more steps, operations or functions of the method 300 may be implemented by a computing device having a processor, a memory and input/output devices as illustrated below in FIG. 4, specifically programmed to perform the steps, functions and/or operations of the method. Although any one of the elements in system 100 may be configured to perform various steps, operations or functions of the method 300, the method will now be described in terms of an example where steps or operations of the method are performed by a processor, such as processor 402 in FIG. 4.

The method 300 begins at step 305 and proceeds to step 310. At step 310, the processor receives survey data for a plurality of customers of the telecommunication service provider network for a given time period, the survey data identifying whether each of the plurality of customers is willing to recommend the telecommunication service provider network. In one example, the survey data may comprise customers' responses to a survey inquiring as to the customers' levels of satisfaction with various aspects of the services provided to the customers by the telecommunication service provider network. In one example, the survey may include at least an inquiry as to whether the customers are willing to recommend the telecommunication service provider network to others. Thus, a customer's response may include at least an answer of whether the customer is willing to recommend the telecommunication service provider network to others. In addition, in one example, the surveys may ask whether a customer has experienced any of a number of particular problems within a given time period, such as whether the customer has experienced a loss of service for greater than six hours within the last three months, whether the customer has had a service problem that required more than two phone calls with technical support personnel in order to resolve, whether the customer has incurred overage charges, shortfall charges, and so forth. The surveys may be in an electronic format, such as extensible markup language (XML) form based surveys and/or interactive webpages, or may be presented via automated phone calls to endpoint devices of the customers.

At step 320, the processor identifies detractors from the plurality of customers, the detractors comprising customers that are not willing to recommend the telecommunication service provider network. In one example, the detractors may be identified from the survey data of customers in which the customers indicated an unwillingness to recommend the telecommunication service provider network.

At step 330, the processor collects customer event data for the detractors for the given time period. In one example, the customer event data may comprise operational data that is collected from various centralized system components such as: a billing system, a customer relationship management (CRM) system, a trouble ticket system, an ordering system, a fulfillment system, or a contracting system. In one example, the processor may collect the customer event data for the detractors, as well as for other customers, on an ongoing basis. In other words, the customer event data may be collected prior to and/or simultaneous with the administration of customer surveys and the collection of the survey data comprising customers' responses to the survey. In another example, the processor may retrieve customer event data for the detractors from one or more centralized system components after determining which customers comprise the detractors. For example, the centralized system components may store customer event data for time periods that have already occurred, including the given time period. As such, the processor may query one or more of the respective centralized system components to retrieve the customer event data for the detractors.

At step 340, the processor identifies detractor trigger events from the customer event data, where the detractor trigger events comprise billing events from the customer event data that are correlated with the detractors. In one example, the billing events comprise types of customer events/operational events that impact customer billing records of the telecommunication service provider network, such as a contract end event, a contract shortfall event, an excess usage event, or a late disconnect event. In one example, a billing event is determined to be correlated with the detractors (and thus to comprise one of the detractor trigger events) when a percentage of the detractors greater than a threshold are determined to have experienced the billing event.

At step 350, the processor detects an occurrence of one of the detractor trigger events associated with a first customer of the telecommunication service provider network. In one example, the occurrence of the one of the detractor trigger events is detected via one of the systems of the telecommunication service provider network, such as the billing system, the customer relationship management system, the trouble ticket system, the ordering system, the fulfillment system, or the contracting system. For instance, the processor may configure and/or send instructions to one or more of the systems to send an alert to the processor when the operational data/customer event data is indicative of an occurrence of one of the detractor trigger events. Alternatively, or in addition, the processor may continue to gather operational data from one or more centralized system components, from which the processor may determine an occurrence of a detractor trigger event.

At step 360, the processor adjusts a billing record for the first customer in response to detecting the occurrence of the one of the detractor trigger events. In one example, the adjusting results in a lesser charge to the first customer than without the adjusting. For instance, a detractor trigger event comprising an excess usage event may be detected, and the customer billing record may be adjusted to provide a most favored customer rate for the excess usage associated with the excess usage event. For example, the customer may be charged at best rate that is offered to other customers. In another example, the customer may be charged at a rate that is equivalent to a rate for usage that is not in excess of a contractual amount. For instance, if a customer's contractual rate is 2 gigabytes per month for $20.00, usage in excess of 2 gigabytes will not be charged at a higher rate, but will be charged at the same rate for usage that is not in excess of 2 gigabytes. In another example, the detractor trigger event that is detected may comprise a contract end event, and the adjusting the billing record may comprise providing a contractual service rate according to a contract that was in place prior to the contract end event. In another example, the detractor trigger event that is detected may comprise a contract shortfall event, and the adjusting the billing record may comprise providing a credit to a customer account for a billing period subsequent to the billing period in which an amount was charged to the customer account for the contract shortfall event. In another example, the detractor trigger event that is detected may comprise a late disconnect event, where a telecommunication service of a customer is disconnected after a contractual date or a target date by which telecommunication service provider network agreed to disconnect the service. In such an example, the adjusting the billing record may comprise removing a charge for the telecommunication service for a time period after the contractual date or the target date.

Following step 360, the method 300 proceeds to step 395 where the method ends. It should be noted that the method 300 may be expanded to include additional steps. For example, the method 300 may continue to gather survey data and customer event data for subsequent time periods, determine detractors, identify detractor trigger events, determine occurrences of detractor trigger events, and adjust customer billing records in response thereto. As such, the present method 300 may adapt to changing conditions of the telecommunication service provider network, the customer event data, and detractor trigger events from one time period to the next. For instance, the customer events that are the most indicative of a customer becoming a detractor may change over time. In another example, the method 300 may be expanded to include automatically scheduling personnel of the telecommunication service provider network to intervene and contact the customer as a follow up to any automatic adjustments to the customer's billing record. Similarly, in another example, if the detractor trigger event comprises a contract end event, the method 300 may further include sending an automatic notification to the customer inviting the customer to renew the contract or inviting the customer to negotiate a new contract. The automatic notification may be provided via various types of communications, such as via email, an automated phone call, e.g., an interactive voice response (IVR) call, via a paper bill mailed to the customer, and so forth. In still another example, where the processor determines that the ending of a contract comprises a detractor trigger event, the method 300 may further include scheduling an alertJtrigger for a time prior to the expiration of a customer contract, e.g., 60 days in advance, 30 days, in advance, etc., and automatically sending a notification to the customer reminding the customer of the upcoming contract expiration and inviting the customer to renew the contract and/or to negotiate a new contract.

In addition, although not specifically specified, one or more steps, functions or operations of the method 300 may include a storing, displaying and/or outputting step as required for a particular application. In other words, any data, records, fields, and/or intermediate results discussed in the method 300 can be stored, displayed and/or outputted either on the device executing the method 300, or to another device, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

As such, the present disclosure provides at least one advancement in the technical field of telecommunication service provider network operations. This advancement is in addition to the traditional methods of human personnel manually responding to customer complaints regarding network operations. In particular, examples of the present disclosure automatically determine operational events (e.g., billing events) that may comprise detractor trigger events, detect additional occurrences of such billing events, and adjust billing records for customers in response to detecting occurrences of such billing events that comprise detractor trigger events. This leads to more efficient operating of the telecommunication service provider network, greater customer satisfaction, and better and more efficient use of human resources within an organization.

The present disclosure also provides a transformation of data, e.g., operational data/customer event data is generated by one or more centralized system components. The operational data is gathered, stored, correlated, and analyzed, and is transformed into additional data or new data that indicates which customer events may comprise detractor trigger events. In addition, new data is generated insofar as new alerts are configured to detect further occurrences of such detractor trigger events that are determined or derived from the operational data/customer event data.

Finally, examples of the present disclosure improve the functioning of a computing device, e.g., a server. Namely, a server for deployed in the telecommunication service provider network is improved by the use of operational data/customer event data that is generated by one or more centralized system components, which is processed via the operations of the present disclosure to determine billing events that may comprise detractor trigger events, and to then detect additional occurrences of such detractor trigger events that are determined or derived from the operational data/customer event data.

FIG. 4 depicts a high-level block diagram of a computing device specifically programmed to perform the functions described herein. As depicted in FIG. 4, the system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for adjusting a billing record for a customer in response to detecting an occurrence of a detractor trigger event, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the method, or the entire method is implemented across multiple or parallel computing devices, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

The one or more hardware processors 402 can also be configured or programmed to cause other devices to perform one or more operations as discussed above. In other words, the one or more hardware processors 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method. In one example, instructions and data for the present module or process 405 for adjusting a billing record for a customer in response to detecting an occurrence of a detractor trigger event (e.g., a software program comprising computer-executable instructions) can be loaded into memory 404 and executed by hardware processor element 402 to implement the steps, functions or operations as discussed above in connection with the illustrative method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for adjusting a billing record for a customer in response to detecting an occurrence of a detractor trigger event (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A device, comprising:
a processor of a telecommunication service provider network; and
a computer-readable storage medium storing instructions which, when executed by the processor, cause the processor to perform operations, the operations comprising:
receiving survey data for a plurality of customers of the telecommunication service provider network for a given time period, the survey data identifying whether each of the plurality of customers is willing to recommend the telecommunication service provider network;
identifying detractors from the plurality of customers, the detractors comprising customers that are not willing to recommend the telecommunication service provider network;
collecting customer event data for the detractors for the given time period;
identifying detractor trigger events from the customer event data, wherein the detractor trigger events comprise billing events from the customer event data that are correlated with the detractors;
detecting an occurrence of one of the detractor trigger events associated with a first customer of the telecommunication service provider network; and
adjusting a billing record for the first customer in response to detecting the occurrence of the one of the detractor trigger events, wherein the adjusting results in a lesser charge to the first customer than without the adjusting.

2. The device of claim 1, wherein the billing events comprise types of customer events that impact customer billing records of the telecommunication service provider network.

3. The device of claim 1, wherein the one of the detractor trigger events comprises: a contract end event, a contract shortfall event, an excess usage event, or a late disconnect event.

4. The device of claim 3, wherein the one of the detractor trigger events comprises the excess usage event, wherein the adjusting the billing record comprises providing a most favored customer rate to the first customer for excess usage associated with the excess usage event.

5. The device of claim 3, wherein the one of the detractor trigger events comprises the contract end event, wherein the adjusting the billing record comprises providing a contractual service rate to the first customer according to a contract associated with the contract end event, after an end of a contractual time period associated with the contract.

6. The device of claim 3, wherein the one of the detractor trigger events comprises a contract shortfall event, wherein the adjusting the billing record comprises charging a customer account of the first customer in an amount for a contract shortfall associated with the contract shortfall event for a first billing period, and providing a credit to the customer account of the first customer for at least a second billing period that is subsequent to the first billing period, the credit associated with the amount charged to the customer account for the contract shortfall.

7. The device of claim 3, wherein the one of the detractor trigger events comprises the late disconnect event, wherein the late disconnect event comprises a disconnection of a telecommunication service after a contractual date by which the telecommunication service was to be disconnected, wherein the adjusting the billing record comprises removing a charge for the telecommunication service for a time period after the contractual date.

8. The device of claim 1, wherein the customer event data comprises data obtained from a system of the telecommunication service provider network comprising at least one of: a billing system, a customer relationship management system, a trouble ticket system, an ordering system, a fulfillment system, or a contracting system.

9. The device of claim 8, wherein the occurrence of the one of the detractor trigger events associated with the first customer of the telecommunication service provider network is detected via the system of the telecommunication service provider network.

10. The device of claim 1, wherein the one of the detractor trigger events is determined to be correlated with the detractors when a percentage of the detractors greater than a threshold are determined to have experienced the one of the detractor trigger events.

11. A method, comprising:
receiving, by a processor of a telecommunication service provider network, survey data for a plurality of customers of the telecommunication service provider network for a given time period, the survey data identifying whether each of the plurality of customers is willing to recommend the telecommunication service provider network;
identifying, by the processor, detractors from the plurality of customers, the detractors comprising customers that are not willing to recommend the telecommunication service provider network;
collecting, by the processor, customer event data for the detractors for the given time period;
identifying, by the processor, detractor trigger events from the customer event data, wherein the detractor trigger events comprise billing events from the customer event data that are correlated with the detractors;
detecting, by the processor, an occurrence of one of the detractor trigger events associated with a first customer of the telecommunication service provider network; and
adjusting, by the processor, a billing record for the first customer in response to detecting the occurrence of the one of the detractor trigger events, wherein the adjusting results in a lesser charge to the first customer than without the adjusting.

12. The method of claim 11, wherein the billing events comprise types of customer events that impact customer billing records of the telecommunication service provider network.

13. The method of claim 11, wherein the one of the detractor trigger events comprises: a contract end event, a contract shortfall event, an excess usage event, or a late disconnect event.

14. The method of claim 13, wherein the one of the detractor trigger events comprises the excess usage event, wherein the adjusting the billing record comprises providing a most favored customer rate to the first customer for excess usage associated with the excess usage event.

15. The method of claim 13, wherein the one of the detractor trigger events comprises the contract end event, wherein the adjusting the billing record comprises providing a contractual service rate to the first customer according to a contract associated with the contract end event, after an end of a contractual time period associated with the contract.

16. The method of claim 13, wherein the one of the detractor trigger events comprises a contract shortfall event, wherein the adjusting the billing record comprises charging a customer account of the first customer in an amount for a contract shortfall associated with the contract shortfall event for a first billing period, and providing a credit to the customer account of the first customer for at least a second billing period that is subsequent to the first billing period, the credit associated the amount charged to the customer account for the contract shortfall.

17. The method of claim 13, wherein the one of the detractor trigger events comprises the late disconnect event, wherein the late disconnect event comprises a disconnection of a telecommunication service after a contractual date by which the telecommunication service was to be disconnected, wherein the adjusting the billing record comprises removing a charge for the telecommunication service for a time period after the contractual date.

18. The method of claim 11, wherein the customer event data comprises data obtained from a system of the telecommunication service provider network comprising at least one of: a billing system, a customer relationship management system, a trouble ticket system, an ordering system, a fulfillment system, or a contracting system.

19. The method of claim 18, wherein the occurrence of the one of the detractor trigger events associated with the first customer of the telecommunication service provider network is detected via the system of the telecommunication service provider network.

20. A non-transitory computer-readable storage medium storing instructions which, when executed by a processor of a telecommunication service provider network, cause the processor to perform operations, the operations comprising:
receiving survey data for a plurality of customers of the telecommunication service provider network for a given time period, the survey data identifying whether each of the plurality of customers is willing to recommend the telecommunication service provider network;
identifying detractors from the plurality of customers, the detractors comprising customers that are not willing to recommend the telecommunication service provider network;
collecting customer event data for the detractors for the given time period;
identifying detractor trigger events from the customer event data, wherein the detractor trigger events comprise billing events from the customer event data that are correlated with the detractors;
detecting an occurrence of one of the detractor trigger events associated with a first customer of the telecommunication service provider network; and
adjusting a billing record for the first customer in response to detecting the occurrence of the one of the detractor trigger events, wherein the adjusting results in a lesser charge to the first customer than without the adjusting.
